(19) United States
(12) Patent Application Publication
(10) Pub. No.: US 2010/0161527 A1
(43) Pub. Date: Jun. 24, 2010

(54) EFFICIENTLY BUILDING COMPACT MODELS FOR LARGE TAXONOMY TEXT CLASSIFICATION

(75) Inventors: Sundararajan SELLAMANICKAM, Bangalore (IN); Sathiya Keerthi SELVARAJ, Cupertino, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/342,750

(22) Filed: Dec. 23, 2008

(51) Int. Cl. G06F 15/18

(52) U.S. Cl. 706/12

(57) ABSTRACT

A taxonomy model is determined with a reduced number of weights. For example, the taxonomy model is a tangible representation of a hierarchy of nodes that represents a hierarchy of classes that, when labeled with a representation of a combination of weights, is usable to classify documents having known features but unknown class. For each node of the taxonomy, the training example documents are processed to determine the features for which there are a sufficient number of training example documents having a class label corresponding to at least one of the leaf nodes of a subtree having that node as a root node. For each node of the taxonomy, a sparse weight vector is determined for that node, including setting zero weights, for that node, those features determined to not appear at least a minimum number of times in a given set of leaf nodes in the sub-tree with that node as a root node. The sparse weight vectors can be learned by solving an optimization problem using a maximum entropy classifier, or a large margin classifier with a sequential dual method (SDM) with margin or slack resealing. The determined sparse weight vectors are tangibly embodied in a computer-readable medium in association with the tangible representation of the nodes of the taxonomy.

### BACKGROUND

Classification of web objects (such as images and web pages) is a task that arises in many online application domains of online service providers. Many of these applications are ideally provided with quick response time, such that fast classification can be very important. Use of a small classification model can contribute to a quick response time.

Classification of web pages is an important challenge. For example, classifying shopping related web pages into classes like product or non-product is important. Such classification is very useful for applications like information extraction and search. Similarly, classification of images in an image corpus (such as maintained by the online “flickr” service, provided by Yahoo Inc. of Sunnyvale, Calif.) into various classes is very useful.

One method of classification includes developing a taxonomy model using training examples, and then determining classification of unknown examples using the trained taxonomy model. Development of taxonomy models (such as those that arise in text classification) typically involve large numbers of nodes, classes, features and training examples, and face the following challenges: (1) memory issues associated with loading a large number of weights during training; (2) the final model having a large number of weights, which is bothersome during classifier deployment; and (3) slow training.

For example, multi-class text classification problems arise in document and query classification problems in many application domains, either directly as multi-class problems or in the context of developing taxonomies. Taxonomy classification problems that arise within Yahoo!, for example, include Yahoo! directory, key-words, ads and page categorization to Darwin taxonomy etc. For example, in simple Yahoo! directory taxonomy structure, there are top level categories like arts, Business and Economy, health, Sports, Science, etc. In the next level, each of these categories is further divided into sub-categories. For example, the health category is divided into sub-categories of fitness, medicine etc. Such taxonomy structure information is very useful in building high-performance classifiers.

### SUMMARY

In accordance with an aspect, a taxonomy model is determined with a reduced number of weights. For example, the taxonomy model is a tangible representation of a hierarchy of nodes that represents a hierarchy of classes that, when labeled with a representation of a combination of weights, is usable to classify documents having known features but unknown class. For each node of the taxonomy, the training example documents are processed to determine the features for which there are a sufficient number of training example documents having a class label corresponding to at least one of the leaf nodes of a subtree having that node as a root node. For each node of the taxonomy, a sparse weight vector is determined for that node, including setting zero weights, for that node, those features determined to not appear at least a minimum number of times in a given set of leaf nodes in the sub-tree with that node as a root node. The sparse weight vectors can be learned by solving an optimization problem using a maximum entropy classifier, or a large margin classifier with a sequential dual method (SDM) with margin or slack resealing. The determined sparse weight vectors are tangibly embodied in a computer-readable medium in association with the tangible representation of the nodes of the taxonomy.

### BRIEF DESCRIPTION OF THE FIGURES

FIG. 1 is a block diagram illustrating a basic background regarding classifiers and learning.

FIG. 2 is a simplistic diagram illustrating a taxonomy usable for classification.

FIG. 3 is a block diagram broadly illustrating how the model parameters, used in classifying examples to a taxonomy of classifications, may be determined.

FIG. 4 is a block diagram illustrating learning of sparse representation in a taxonomy setup for which intensity of computational and memory resources may be lessened.

FIG. 5 is a simplified diagram of a network environment in which specific embodiments of the present invention may be implemented.

### DETAILED DESCRIPTION

The inventors have realized that many classification tasks are associated with real time (or near real time) applications, where fast classification is very important, and so it can be desirable to load a small model in main memory during deployment. We describe herein a basic method of reducing the total number of weights used in a taxonomy classification model, and we also describe various instantiations of taxonomy algorithms that address one or more of the above three problems.

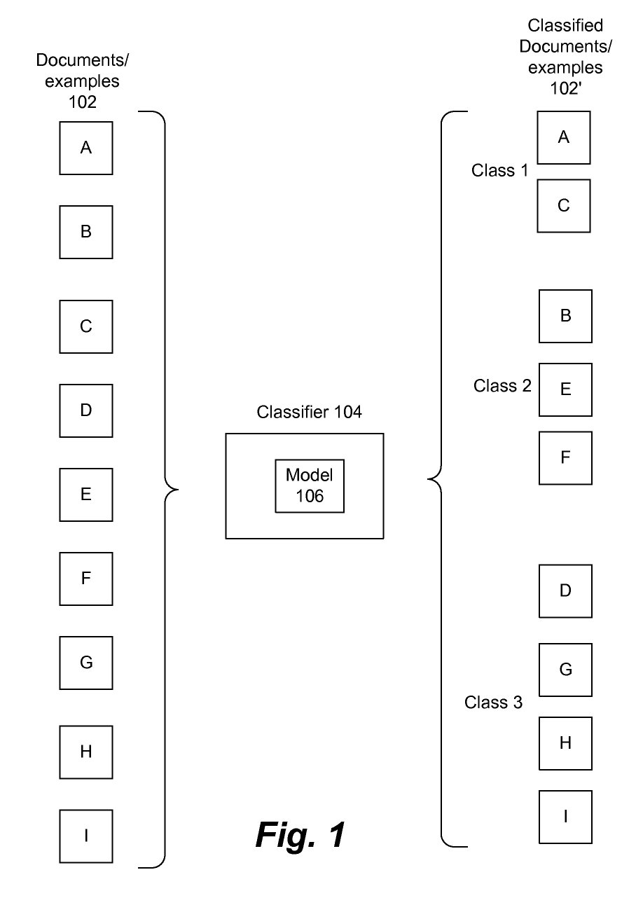

Before discussing the issues of computation costs for classification learning, we first provide some basic background regarding classifiers and learning. Referring to FIG. 1, along the left side, a plurality of web pages 102 A, B, C, . . . , G are represented. These are web pages (more generically, “examples”) to be classified. A classifier 104, operating according to a model 106, classifies the web pages 102 into classifications Class 1, Class 2 and Class 3. The classified web pages are indicated in FIG. 1 as documents/examples 102′. For example, the model 106 may exist on one or more servers.

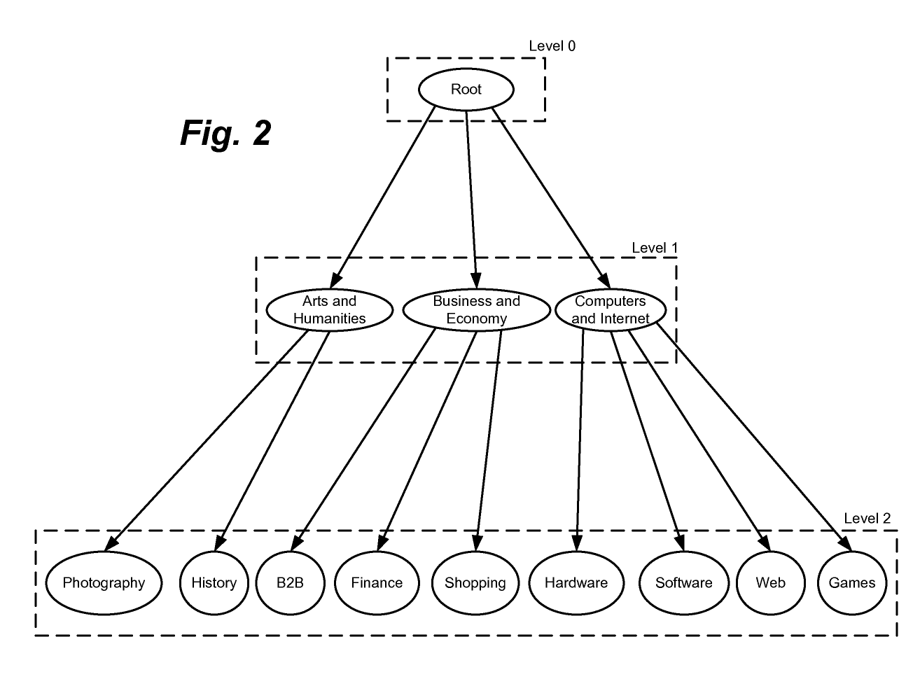

More particularly, the classifications may exist within the context of a taxonomy. For example, FIG. 2 illustrates such a taxonomy based, in this example, on categories employed by Yahoo! Directory. Referring to FIG. 2, the top level (Level 0) is a root level. The next level down (Level 1) includes three sub-categories of Arts and Humanities; Business and Economy; and Computers and Internet. The next level down (Level 2) includes sub-categories for each of the sub-categories of Level 1. In particular, for the Arts and Humanities sub-category of Level 1, Level 2 includes sub-categories of Photography and History. For the Business and Economy sub-category of Level 1, Level 2 includes sub-categories of B2B, Finance and Shopping. For the Computers and Internet sub-category of Level 1, Level 2 includes sub-categories of Hardware, Software, Web and Games. It is noted that the FIG. 2 taxonomy is only a simplistic example of a taxonomy and, in practice, the taxonomies of classifications generally include many classifications and levels, and are generally much more complex than the FIG. 2 example.

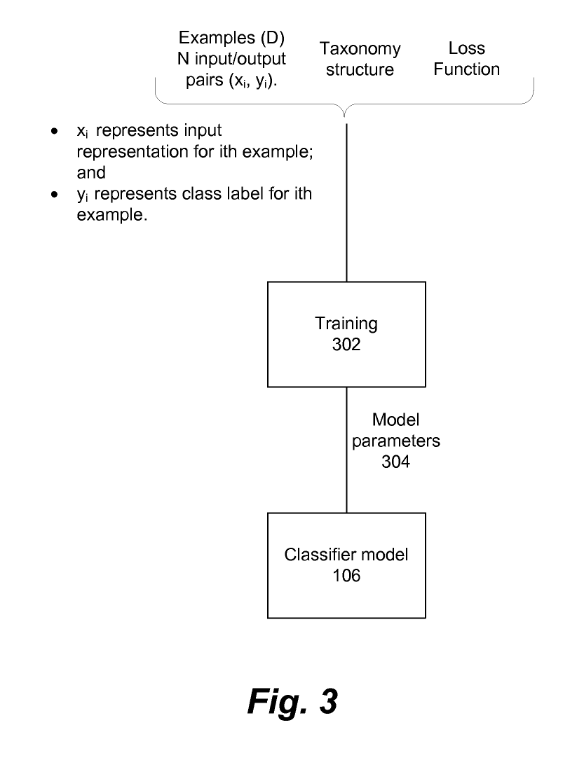

Referring now to FIG. 3, this figure broadly illustrates how the model parameters, using in classifying, may be determined. Generally, examples (D) and known classifications may be provided to a training process 302, which determines the model parameters 304 and thus populates the classifier model 106. For example, the examples D provided to the training process 302 may include N input/output pairs (xᵢ, yᵢ), where xᵢ represents the input representation for the i-th example D, and yᵢ represents a class label for the i-th example D. The class label for training may be provided by a human or by some other means and, for the purposes of the training process 302, is generally considered to be a given. The inputs also include a taxonomy structure (like an example shown in FIG. 2) and a loss function matrix (as described below).

Particular cases of the training process 302 are the focus of this patent application. In the description that follows, we discuss reducing the total number of weights used in a taxonomy classification model. Again, it is noted that the focus of this patent application is on particular cases of a training process, within the environment taxonomy-type classifiers.

Before describing details of such training processes, it is useful to collect here some notations that are used in this patent application. We use the term “example” and “document” interchangeably. A training set is given, and it includes l training examples. One training example includes a vectoral representation of a document and its corresponding class label.

For example, let n be the number of input features and k be the number of classes. Throughout, the index i is used to denote a training example and the index m is used to denote a class. Unless otherwise mentioned, i will run from 1 to l and m will run from 1 to k. Let yᵢ ∈ {1, . . . , k} denote the class label of example i. In a traditional taxonomy model using a full feature representation, xᵢ ∈ Rⁿ is the input vector associated with the i-th example. In a taxonomy representation problem, a taxonomy structure (for example, a tree) is provided having internal nodes and leaf nodes. Then the leaf nodes represent the classes.

According to the notation used herein, the index j is used to denote a node and runs from 1 to nn. The taxonomy structure is represented as a matrix Z of size nn×k and each element takes a value from {0,1}. For example, the m th column in Z (denoted as Zₘ) represents the set of active/non-active nodes for the class m; that is, if a node is active then the corresponding element is 1, else the corresponding element is 0.

In the taxonomy model, each node is associated with a weight vector wⱼ ∈ Rⁿ, and let W ∈ R^{nn×n} denote the combined weight vector that collects all wⱼ over j=1, . . . nn. We also define φₘ(xᵢ)=Zₘ [symbol] xᵢ. The operator [symbol] is defined as: [symbol] :{0,1}ⁿⁿ×Rⁿ→R^{nn×n},(Zₘ [symbol] xᵢ)_{p+(q-1)*n}=z_{m,q}x_{i,p} where z_{m,q} denotes the q th element of the column vector Zₘ and x_{i,p} denotes the p th element of the input xᵢ. For ease of notation, we write φ_{i,m}=φₘ(xᵢ). Then we write the output for class m (corresponding to the input xᵢ) as o_{i,m}=W^{T}φ_{i,m}. In the reduced feature representation described herein, xᵢ^{j} denotes the reduced representation of xᵢ for node j. For a generic vector x outside the training set, the subscript i is simply omitted and x^{j} denotes the reduced representation of x for node j. We use superscript R to distinguish an item associated with reduced feature representation.

Turning now to describing some examples of developing and using taxonomy models with a reduced number of weights, we note that Support Vector Machines (SVMs) and Maximum Entropy classifiers are state of the art methods for multi-class text classification with a large number of features and training examples (recall that each training example is a document labeled with a class) connected by a sparse data matrix. See, e.g., T. Hastie, R. Tibshirani, and J. Friedman. The Elements of Statistical Learning: Data Mining, Inference, and Prediction. Springer Series in Statistics. Springer Book, 2002. These methods either operate directly on the multi-class problem or in a one-versus-rest mode where, for each class, a binary classification problem of separating it from the other classes is developed. The multi-class problem may have additional information like taxonomy structure, which can be used to define more appropriate loss functions and build better classifiers.

We call such a problem a taxonomy problem and focus on finding efficient solutions to the taxonomy problem. Suppose a generic example (document) is represented using a large number of bag-of-word or other features, into a vector x sitting in a feature space of dimension n where n is large. The taxonomy methods use one weight vector W that yields the score for class m as:

sₘ(x)=W^{T}φₘ(x) Equation (1)

where T denotes the vector transpose. Note that this score can also be written as:

$${s}_{m} ( x ) = {\sum }_{j = 1}^{nn} {{z}_{j , m} ( {w}_{j} )}^{T} x \qquad ( Equation 2 )$$

The decision function of choosing the winning class is given by the class with the highest score:

argmaxₘ sₘ(x). (Equation 3)

With W including nn weight (sub)vector for each node, there are n×nn weight variables in the model, where nn is the total number of nodes. The number of variables can be prohibitively large when both the number of features and the number of nodes are large, e.g., consider the case of a million features and a thousand nodes. In real-time applications (i.e., applications for which it is required or desired that classification occur quickly), loading a model with such a large number of weights during deployment is very hard. The large number of weights also makes the training process slow and challenging to handle in memory (since many vectors having the dimension of the number of weight variables are employed in the training process). The large number of weights also make the prediction process slow, as more computation time is needed to make predictions (that is, to decide the winning class via (Equation 3)).

One conventional approach to reducing the number of weight variables is to combine the training process with a method that selects important weight variables and removes the others. An example of such a method is the method of Recursive Feature Elimination (RFE). Though effective, these methods are typically expensive since, during training, all variables are still involved.

The inventors describe herein a much simpler approach that is, nevertheless, very effective. A central idea of one example of the method is the following: choose a sparse weight vector for each node, with non-zero weights permitted only for features that appear at least a certain minimum number of times in the given set of leaf nodes(classes) in the sub-tree with this node as the root node. The inventors have recognized that these features encode the “most” (or, at least, sufficient) information, and the other features are somewhat redundant in forming the scoring function for that node. To be more precise, given a training set of labeled documents, for the j-th node, the full x is not used, but rather a subset vector x^{j} is used, which includes only the feature elements of x for which there is at least lₜₕ^{m} training examples xᵢ with label m belonging to at least one of the classes (leaf nodes) with a non-zero value for that feature element. lₜₕ^{m} is a threshold size that can be set to a small number, such as an integer between 1 and 5. As a special case, the same threshold may be set for all the classes.

Let n^{j} denote the number of such chosen features for node j, i.e., the dimension of x^{j}. Using wⱼ^{R} to denote the reduced weight vector for node j, leads to the modified scoring function,

$${s}_{m}^{R} ( x ) = {\sum }_{j = 1}^{nn} {{z}_{j , m} ( {w}_{j}^{R} )}^{T} {x}^{j} \qquad ( Equation 4 )$$

Thus the total number of weight variables in such a reduced model is N^{R}=Σⱼn^{J} as opposed to N=n×nn in the full model. Typically N^{R} is much smaller than N. Referring to an earlier example of the case of a million features and a thousand nodes, if there are roughly 10⁴ non-zero features for each node, then N=10⁹ versus N^{R}=10⁷, which is two orders of magnitude reduction in the total number of weights. The following illustrates an example of steps of the method.

1. Do the following two steps:
(a) For each node j, use the training set to find the features for which there are at least lₜₕ^{m} training examples xᵢ with label m belonging to at least one of the leaf nodes(classes) with a non-zero value for that feature element. This identifies feature elements that determine x^{j} for any given x. Obtain xᵢ^{j} ∀j,i.
(b) Use a taxonomy method together with the training set {{xᵢ^{j}}ⱼ,yᵢ}ᵢ to determine the set of weight vectors, {wⱼ^{R}}ⱼ

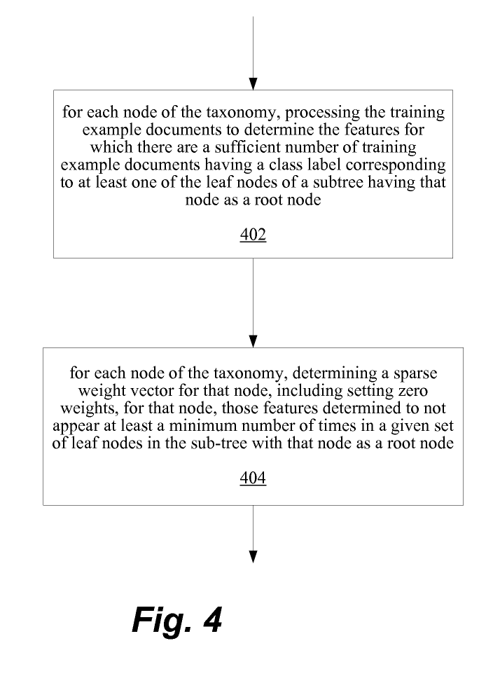

FIG. 4 illustrates an example of the method in a broad aspect, in flowchart form. At 402, for each node of the taxonomy, the training example documents are processed to determine the features for which there are a sufficient number of training example documents having a class label corresponding to at least one of the leaf nodes of a subtree having that node as a root node. At 404, for each node of the taxonomy, a sparse weight vector is determined for that node, including setting zero weights, for that node, those features determined to not appear at least a minimum number of times in a given set of leaf nodes in the sub-tree with that node as a root node.

More particularly, for step (b) of the above algorithm, it is noted that, among other possible methods, one can use one of the following methods: (1) a taxonomy method employing maximum entropy classifier; (2) a taxonomy SVM (large margin) classifier using Cai-Hofmann (CH) formulation and (3) a taxonomy classifier using CH formulation with a Sequential Dual Method (SDM). Examples of applying these methods are discussed below.

For example, as noted above, step (b) of the above algorithm can be implemented by a maximum entropy classifier method. To do this in one example, a class probability for class m is defined as

$${p}_{i}^{m} = \frac{exp ( {s}_{m}^{R} ( {x}_{i} ) )}{{\sum }_{y = 1}^{k} exp ( {s}_{y}^{R} ( {x}_{i} ) )} \qquad ( Equation 5 )$$

where

$${s}_{m}^{R} ( {x}_{i} ) = {\sum }_{j = 1}^{nn} {{z}_{j , m} ( {w}_{j}^{R} )}^{T} {x}_{i}^{j} .$$

Joint training of all weights, {wⱼ^{R}}ⱼ₋₁ⁿⁿ is done by solving the optimization problem

$$min \frac{C}{2} {\sum }_{j} {‖ {w}_{j}^{R} ‖}^{2} - {\sum }_{i} log {p}_{i}^{m} \qquad ( Equation 6 )$$

where C is a regularization constant that is either fixed at some chosen value, say C=1 or may be chosen by cross validation. The steps immediately below illustrate a specific example of steps to solve the maximum entropy classifier method.

1. Do the following two steps:
(a) Set-up max-ent probabilities via (Equation 5).
(b) Solve (Equation 6) using a suitable nonlinear optimization technique to get {wⱼ^{R}}, e.g., L-BFGS (as described, for example, in R. H. Byrd, P. Lu, J. Nocedal, and C. Zhu. A limited memory algorithm for bound constrained optimization. SIAM J. Sci. Statist. Comput., 16:1190-1208, 1995.
   As mentioned above, the weight vectors may also be determined using a Sequential Dual Method for large margin classifier of a Cai-Hoffmann formulation. For example, Cai and Hofmann proposed an approach for the taxonomy problem, but which the inventors modify to handle the reduced feature representation. See L. Cai and T. Hofmann. Hierarchical document categorization with support vector machines. In ACM Thirteenth Conference on Information and Knowledge Management (CIKM), 2004.

$$min \frac{C}{2} {‖ {W}^{R} ‖}^{2} + {\sum }_{i} {ξ}_{i} \\ s . t . {s}_{{y}_{i}}^{R} ( {x}_{i} ) - {s}_{m}^{R} ( {x}_{i} ) \geq {e}_{i , m} - {ξ}_{i} ∀ m , i \qquad ( Equation 7 )$$

where C is a regularization constant, e_{i,m}=1−δ_{y}_{ᵢ}_{,m} and δ_{y}_{ᵢ}ₘ=1 if yᵢ=m, δ_{y}_{ᵢ}_{,m}=0 if yᵢ≠m. Note that, in (Equation 7) the constraint for m=yᵢ corresponds to the non-negativity constraint, ξᵢ≧0.

The dual problem of (Equation 7) involves a vector α having dual variables α_{i,m} ∀m,i. Let us define

$${W}^{R} ( α ) = {\sum }_{i , m} {α}_{i , m} ( {ϕ}_{i , {y}_{i}}^{R} - {ϕ}_{i , m}^{R} ) . \qquad ( Equation 8 )$$

Here φ_{i,y}_{ᵢ}^{R} and φ_{i,m}^{R} denote the reduced feature representations obtained from applying the operator [symbol] with Z_{y}_{ᵢ} and Zₘ on xi (by using xᵢ^{j} for each node j ) respectively. The above expression is to be understood with sum and difference operations taking place on an appropriate feature element of each node depending on whether that node is active. To be precise, absence of a feature element can be conceptually visualized as element with a 0 value and no computation actually takes place. The dual problem is

$${min }_{α} f ( α ) = \frac{1}{2 C} {‖ {W}^{R} ( α ) ‖}^{2} - {\sum }_{i} {\sum }_{m} {e}_{i , m} {α}_{i , m} \\ s . t . ( 0 \leq {α}_{i , m} \leq 1 ∀ m , {\sum }_{m} {α}_{i , m} = 1 ) ∀ i \qquad ( Equation 9 )$$

The derivative of f is given by

$${g}_{i}^{m} = \frac{\partial f ( α )}{\partial {α}_{i , m}} = ( {s}_{{y}_{i}}^{R} ( {x}_{i} ) - {s}_{m}^{R} ( {x}_{i} ) ) - {e}_{i , m} ∀ i , m \neq {y}_{i} . \qquad ( Equation 10 )$$

Note that CW^{R}=W^{R}(α). Optimality of α for (9) can be checked using v_{i,m},m≠yᵢ defined as:

$${v}_{i , m} = ( \begin{matrix}\vert {g}_{i , m} \vert & if 0 < {α}_{i , m} < 1 , \\ min ( 0 , {g}_{i , m} ) & if {α}_{i , m} = 0 , \\ max ( 0 , {g}_{i , m} ) & if {α}_{i , m} = 1\end{matrix} ) \qquad ( Equation 11 )$$

Optimality holds when:

v_{i,m}=0∀m≠yᵢ,∀i. (Equation 12)

For practical termination, an approximate check can be made using a tolerance parameter, ε>0:

v_{i,m}<ε∀m≠yᵢ,∀i. (Equation 13)

An ε value of 0.1 has generally been found to result in suitable solutions.

The Sequential Dual Method (SDM) includes sequentially picking one i at a time and solving the restricted problem of optimizing only α_{i,m} ∀m. To do this, we let δα_{i,m} denote the change to be applied to the current α_{i,m}, and optimize δα_{i,m} ∀m. With A_{i,j}=∥xᵢ^{j}∥² the subproblem of optimizing the δα_{i,m} is given by

$$min \frac{1}{2} {\sum }_{m , {m}^{′}} {δα}_{i , m} {δα}_{i , {m}^{′}} {d}_{i , m , {m}^{′}} - {\sum }_{m} {g}_{i , m} {δα}_{i , m} \\ s . t . - {α}_{i , m} \leq {δα}_{i , m} \leq 1 - {α}_{i , m} ; ∀ m , {\sum }_{m} {δα}_{i , m} = 0 \qquad ( Equation 14 )$$

### Here,

$${d}_{i , m , {m}^{′}} = \frac{1}{C} {\sum }_{j ∈ {J}_{m , {m}^{′}}} {A}_{i , j} , {J}_{m , {m}^{′}} = {I}_{m} ⋂ {I}_{{m}^{′}} and , {I}_{m} , {I}_{{m}^{′}}$$

denote the set of active nodes in Zₘ and Zₘ, respectively. A complete description of SDM for an example of the modified Cai-Hofmann formulation is given in the algorithm below. In the weight update step, the weight sub-vector wⱼ^{R} is updated with xᵢ^{j} scaled by δα_{i,m} for each active node j in each class m.

This can be done efficiently for active nodes that are common across the classes.

1. Initialize α=0 and the corresponding wⱼ^{R}=0 ∀j.

2. Until (Equation 13) holds in an entire loop over examples do:
For i=1, . . . , l
   (a) Compute g_{i,m}∀m≠yᵢ and obtain v_{i,m}
   (b) If max_{m≠y}_{ᵢ}v_{i,m}≠0, solve (Equation 14) and set:
      α_{i,m}→α_{i,m}+δα_{i,m} ∀m
      wⱼ^{R}(α)→wⱼ^{R}(α)−(Σₘδα_{i,m}z_{j,m})xᵢ^{j}
         From (Equation 9), it is noted that, if for some i, m′, α_{i,m′}=1 then α_{i,m}=0, ∀m≠m′ and if α_{i,m}≠1, ∀m then there are at least two non-zero α_{i,m}. For efficiency, (Equation 14) can be solved for some restricted variables, say only the δα_{i,m} for which v_{i,m}>0. Also, in many problems as we approach optimality for many examples α_{i,m′} will stay at 1 for some m′ and α_{i,m}=0, m≠m′. Thus, some heuristics may be applied to speed up algorithm processing. For example, applying the heuristics may include: (1) In each loop, instead of presenting the examples i=1, . . . , l in the given order, one can randomly permute them and then do the updates for one loop over the examples. (2) After a loop through all the examples, we may only update an α_{i,m} if it is non-bounded, and, after a few rounds of such ‘shrunk’ loops (which may be terminated earlier if ε optimality is satisfied on all α_{i,m} variables under consideration), return to the full loop of updating all α_{i,m}. (3) Use a cooling strategy for changing ε, i.e., start with ε=1, solve the problem and then re-solve using ε=0.1.

We now discuss a “loss function” for the taxonomy structure. That is, while the above formulation takes the taxonomy structure into account in learning, the misclassification loss was assumed to be uniform; that is, Δ(y,m)=1−δ_{y,m} where δ_{y,m}=1 if y=m and δ_{y,m}=0 if y≠m. In a taxonomy structure, there is some relationship across the classes. Therefore, it is reasonable to consider loss functions that penalize less when there is confusion between classes that are close and more when there is confusion between classes that are far away. For example, a document confused between Physics and Chemistry sub-categories under Science category may be penalized less compared to confusion between Chemistry and fitness sub-categories that occur under Science and Health categories. Hence, it can be useful to work with a general loss function matrix Δ with (y,m) th element denoted as Δ(y,m)≧0 and Δ(y,m) is the loss of predicting y when the true class is m. Note that y,m∈{1, . . . , k}. When the prediction matches with the true class, the loss is zero; that is, Δ(y,m)=0 if y=m. In general, the loss function matrix Δ(.,.) may be defined by domain experts in real-world applications. For example in a tree, a loss is associated with each non-leaf node and this loss is higher for nodes that occur at a higher level in a tree. Note that the root node has the highest cost. For a given prediction and true class label, the loss is obtained from the first common ancestor node for the nodes that represent prediction and true class label (leaf nodes) in the tree.

Once the taxonomy loss function matrix Δ(.,.) is defined, the above problem formulation may be modified to directly minimize such loss. Two known methods of doing this are: margin re-scaling and slack re-scaling. See, for example, I. Tsochantaridis, T. Joachims, T. Hofmann, and Y. Altun. Large margin methods for structured and interdependent output variables. Journal of Machine Learning Research, 6:113-141, 2005.

In margin re-scaling, the constraints in (Equation 7) are modified as:

s_{y}_{ᵢ}^{R}(xᵢ)−sₘ^{R}(xᵢ)≧Δ(yᵢ,m)−ξᵢ≧∀m,i. (Equation 15)

Essentially, e_{i,m} is replaced with Δ(y_{i,m},m) in the description/formulation described above. In slack re-scaling, the constraints in (Equation 7) are modified as:

$${s}_{{y}_{i}}^{R} ( {x}_{i} ) - {s}_{m}^{R} ( {x}_{i} ) \geq 1 - \frac{{ξ}_{i}}{Δ ( {y}_{i} , m )} , {ξ}_{i} \geq 0 ∀ i , m \neq {y}_{i} . \qquad ( Equation 16 )$$

With this modification of constraints in (Equation 7), the dual formulation and associated (Equation 8) and (Equation 9) change as given below. The dual problem of (Equation 7) with slack re-scaling (Equation 16) involves a vector α having dual variables α_{i,m}m≠yᵢ and (Equation 8) and (Equation 9) are modified as:

$$\begin{matrix} {W}^{R} ( α ) = {\sum }_{{i , m}_{m \neq {y}_{i}}} {α}_{i , m} ( {ϕ}_{i , {y}_{i}}^{R} - {ϕ}_{i , m}^{R} ) & ( Equation 17 ) \\ { min}_{ α} f ( α ) = \frac{1}{2 C} {‖ {W}^{R} ( α ) ‖}^{2} - {\sum }_{i} {\sum }_{m \neq {y}_{i}} {α}_{i , m} \\ s . t . ( 0 \leq {α}_{i , m} \leq Δ ( {y}_{i} , m ) ∀ m \neq {y}_{i} , {\sum }_{m \neq {y}_{i}} \frac{{α}_{i , m}}{Δ ( {y}_{i} , m )} \leq 1 ) ∀ i & ( Equation 18 )\end{matrix}$$

Optimality of α for (18) can be checked using v_{i,m},m≠yᵢ defined as:

$${v}_{i , m} = ( \begin{matrix}\vert {g}_{i , m} \vert & if 0 < {α}_{i , m} < Δ ( {y}_{i} , m ) , \\ min ( 0 , {g}_{i , m} ) & if {α}_{i , m} = 0 , \\ max ( 0 , {g}_{i , m} ) & if {α}_{i , m} = Δ ( {y}_{i} , m )\end{matrix} ) \qquad ( Equation 19 )$$

where g_{i,m} remains the same as given in (Equation 10) and, optimality check using v_{i,m} can be done as earlier with (Equation 12) and (Equation 13).
As earlier, the SDM involves picking an example i and solving the following optimization problem:

$$min \frac{1}{2} {\sum }_{m \neq {y}_{i} , {m}^{′} \neq {y}_{i}} {δα}_{i , m} {δα}_{i , {m}^{′}} {\tilde{d}}_{i , m , {m}^{′}} + {\sum }_{m \neq {y}_{i}} {g}_{i , m} {δα}_{i , m} \\ s . t . - {α}_{i , m} \leq {δα}_{i , m} \leq Δ ( {y}_{i} , m ) - {α}_{i , m} ; ∀ m \neq {y}_{i} , \\ {\sum }_{m \neq {y}_{i}} \frac{{δα}_{i , m}}{Δ ( {y}_{i} , m )} \leq 1 - {\sum }_{m \neq {y}_{i}} \frac{{α}_{i , m}}{Δ ( {y}_{i} , m )} . \qquad ( Equation 20 )$$

### Here,

$${\tilde{d}}_{i , m , {m}^{′}} = \frac{1}{C} {\sum }_{j ∈ {\tilde{J}}_{m , {m}^{′}}} {A}_{i , j} , {\tilde{J}}_{m , {m}^{′}} = {\tilde{I}}_{m} ⋂ {\tilde{I}}_{{m}^{′}} and , {\tilde{I}}_{m} , {\tilde{I}}_{{m}^{′}}$$

denote the set of active nodes (elements with −1) in Z_{y}_{ᵢ}−Zₘ and Z_{y}−Zₘ respectively. A complete description of SDM for our Cai-Hofmann formulation with slack re-scaling is given in the algorithm above, with the following modified α_{i,m} and wⱼ^{R}(α) updates:

$$\begin{matrix}{α}_{i , m} ← {α}_{i , m} + {δα}_{i , m} ∀ m \neq {y}_{i} & ( Equation 21 ) \\ {w}_{j}^{R} ( α ) ← {w}_{j}^{R} ( α ) + ( {\sum }_{m \neq {y}_{i}} {δα}_{i , m} {\tilde{z}}_{j , m} ) {x}_{i}^{j} & ( Equation 22 )\end{matrix}$$

where \tilde{z}_{j,m} is j-th element in Z_{y}_{ᵢ}−Zₘ. From (Equation 18), we note that if for some i, m′, α_{i,m′}=Δ(yᵢ,m′) then α_{i,m}=0, ∀m≠yᵢ,m≠m′. For efficiency, (Equation 20) can be solved for some restricted variables, say only the δα_{i,m} for which v_{i,m}>0. Also, in many problems as we approach optimality for many examples α_{i,m} will stay at Δ(yᵢ, m′) for some m′ and α_{i,m}=0, m≠m′, m≠yᵢ. Also, all the three heuristics described above can be used.

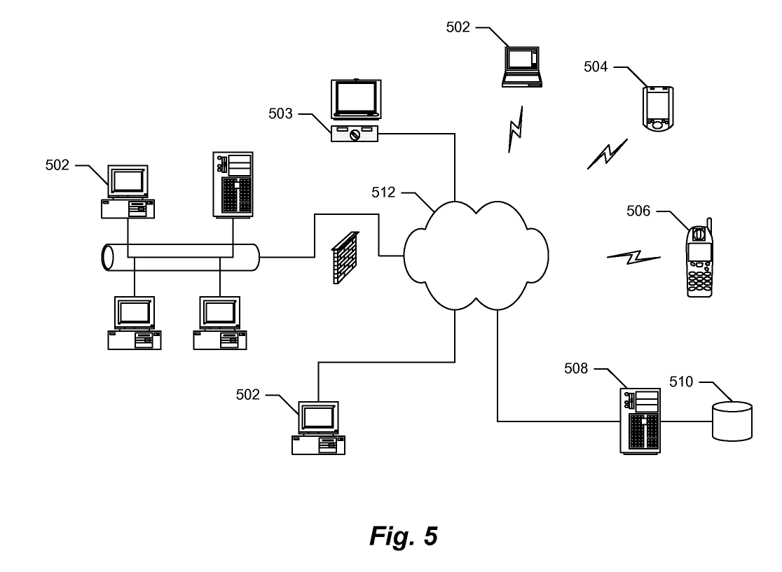

Embodiments of the present invention may be employed to facilitate implementation of classification systems in any of a wide variety of computing contexts. For example, as illustrated in FIG. 5, implementations are contemplated in which users may interact with a diverse network environment via any type of computer (e.g., desktop, laptop, tablet, etc.) 502, media computing platforms 503 (e.g., cable and satellite set top boxes and digital video recorders), handheld computing devices (e.g., PDAs) 504, cell phones 506, or any other type of computing or communication platform.

According to various embodiments, applications may be executed locally, remotely or a combination of both. The remote aspect is illustrated in FIG. 5 by server 508 and data store 510 which, as will be understood, may correspond to multiple distributed devices and data stores.

The various aspects of the invention may be practiced in a wide variety of environments, including network environment (represented, for example, by network 512) including, for example, TCP/IP-based networks, telecommunications networks, wireless networks, etc. In addition, the computer program instructions with which embodiments of the invention are implemented may be stored in any type of tangible computer-readable media, and may be executed according to a variety of computing models including, for example, on a stand-alone computing device, or according to a distributed computing model in which various of the functionalities described herein may be effected or employed at different locations.

We have described the learning and use of a taxonomy classification model with a reduced number of weights. By the classification model having a reduced number of weights, classification using the model may be performed using less computational resources and memory.

What is claimed is:

1. A method of determining a taxonomy model, wherein the taxonomy model is a tangible representation of a hierarchy of nodes that represents a hierarchy of classes that, when labeled with a representation of a combination of weights, is usable to classify documents having known features but unknown class, the method comprising:
for each node of the taxonomy, processing the training example documents to determine the features for which there are a sufficient number of training example documents having a class label corresponding to at least one of the leaf nodes of a subtree having that node as a root node,
for each node of the taxonomy, determining a sparse weight vector for that node, including setting zero weights, for that node, those features determined to not appear at least a minimum number of times in a given set of leaf nodes in the sub-tree with that node as a root node; and
tangibly embodying the determined sparse weight vectors in a computer-readable medium in association with the tangible representation of the nodes of the taxonomy.

2. The method of claim 1, further comprising:
training the taxonomy model by a training process, wherein the training process includes, for each example, applying a vectorial representation of that example and a corresponding class label for that example, to determine a feature representation of each node of the taxonomy.

3. The method of claim 2, wherein the training step includes:
formulating an optimization problem using a maximum entropy classifier; and
solving the optimization problem.

4. The method of claim 2, wherein the training step includes:
formulating an optimization problem using a large margin classifier; and
solving the optimization problem using a sequential dual method.

5. The method of claim 4, wherein:
solving the optimization problem includes applying a margin re-scaling process along with a taxonomy loss function matrix to maximize the margin.

6. The method of claim 4, wherein:
solving the optimization problem includes applying a slack re-scaling process along with a taxonomy loss function matrix to maximize the margin.

7. A computer program product comprising at least one tangible computer readable medium having computer program instructions tangibly embodied thereon, the computer program instructions to configure at least one computing device to determine a taxonomy model, wherein the taxonomy model is a tangible representation of a hierarchy of nodes that represents a hierarchy of classes that, when labeled with a representation of a combination of weights, is usable to classify documents having known features but unknown class, including to:
for each node of the taxonomy, process the training example documents to determine the features for which there are a sufficient number of training example documents having a class label corresponding to at least one of the leaf nodes of a subtree having that node as a root node,
for each node of the taxonomy, determine a sparse weight vector for that node, including setting zero weights, for that node, those features determined to not appear at least a minimum number of times in a given set of leaf nodes in the sub-tree with that node as a root node; and
tangibly embody the determined sparse weight vectors in a computer-readable medium in association with the tangible representation of the nodes of the taxonomy.

8. The computer program product of claim 7, wherein the computer program instructions tangibly embodied on the at least one tangible computer readable medium are further to configure the at least one computing device to:
train the taxonomy model by a training process, wherein the training includes, for each example, applying a vectorial representation of that example and a corresponding class label for that example, to determine a feature representation of each node of the taxonomy.

9. The computer program product of claim 8, wherein the training includes:
formulating an optimization problem using a maximum entropy classifier; and
solving the optimization problem.

10. The computer program product of claim 8, wherein the training includes:
formulating an optimization problem using a large margin classifier; and
solving the optimization problem using a sequential dual method.

11. The computer program product of claim 10, wherein:
solving the optimization problem includes applying a margin re-scaling process along with a taxonomy loss function matrix to maximize the margin.

12. The computer program product of claim 10, wherein:
solving the optimization problem includes applying a slack re-scaling process along with a taxonomy loss function matrix to maximize the margin.

13. A computer system having at least one computing device configured to determine a taxonomy model, wherein the taxonomy model is a tangible representation of a hierarchy of nodes that represents a hierarchy of classes that, when labeled with a representation of a combination of weights, is usable to classify documents having known features but unknown class, including to:
process computer program instructions to, for each node of the taxonomy, process the training example documents to determine the features for which there are a sufficient number of training example documents having a class label corresponding to at least one of the leaf nodes of a subtree having that node as a root node,
process computer program instructions to, for each node of the taxonomy, determine a sparse weight vector for that node, including setting zero weights, for that node, those features determined to not appear at least a minimum number of times in a given set of leaf nodes in the sub-tree with that node as a root node; and
process computer program instructions to tangibly embody the determined sparse weight vectors in a computer-readable medium in association with the tangible representation of the nodes of the taxonomy.

14. The computer system of claim 13, wherein the computer system is further configured to:
process computer program instructions to train the taxonomy model by a training process, wherein the training includes, for each example, applying a vectorial representation of that example and a corresponding class label for that example, to determine a feature representation of each node of the taxonomy.

15. The computer system of claim 14, wherein the training includes:
formulating an optimization problem using a maximum entropy classifier; and
solving the optimization problem.

16. The computer system of claim 14, wherein the training includes:
formulating an optimization problem using a large margin classifier; and
solving the optimization problem using a sequential dual method.

17. The computer system of claim 16, wherein:
solving the optimization problem includes applying a margin re-scaling process along with a taxonomy loss function matrix to maximize the margin.

18. The computer system of claim 16, wherein:
solving the optimization problem includes applying a slack re-scaling process along with a taxonomy loss function matrix to maximize the margin.
